(19) United States
(12) Patent Application Publication
(10) Pub. No.: US 2024/0424474 A1
(43) Pub. Date: Dec. 26, 2024

(54) PYRIDYLETHYLTHIOPROPYL FUNCTIONALIZED SOL-GEL SORBENT AND USES THEREOF

(71) Applicants: The Florida International University Board of Trustees, Miami, FL (US); Aristotle University of Thessaloniki - E.L.K.E., Thessaloniki (GR)

(72) Inventors: Abuzar KABIR, Miami, FL (US); Kenneth G. FURTON, Miami, FL (US); Aristidis ANTHEMIDIS, Thessaloniki (GR); Natalia MANOUSI, Thessaloniki (GR)

(21) Appl. No.: 18/211,814

(22) Filed: Jun. 20, 2023

(51) Int. Cl. B01J 20/22; B01D 15/02; B01J 20/28; B01J 20/30

(52) U.S. Cl. CPC B01J 20/22; B01D 15/02; B01J 20/28016; B01J 20/3085; B01D 2257/60; B01J 2220/4812

(57) ABSTRACT

The present invention provides materials, devices and methods for detecting, determining, monitoring and/or extracting one or more metals such as cadmium, lead, copper, chromium, cobalt, nickel, zinc, manganese, mercury, vanadium, arsenic, and silver in fluid samples. The present invention also provides formulations and methods for synthesizing a metal-extracting materials comprising a pyridylethylthiopropyl functionalized sol-gel silica-based sorbent.

### BACKGROUND OF THE INVENTION

Metals are continuously released in the environment through natural and anthropogenic processes. Some elements or elemental species (e.g., lead, cadmium, mercury etc.) exhibit toxicity even at low concentration levels. Many environmental pollutants have been identified as toxic, carcinogenic, and/or mutagenic that pose serious risk to human health and well-being. Among these toxic pollutants, a few are heavy metals. Heavy metals usually exist as cations such as Pb²⁺, Hg²⁺, Cr⁶⁺, Cr³⁺, Cd²⁺, As³⁺, Co²⁺, Cu²⁺, Ni²⁺, Zn²⁺, and Ag⁺. Heavy metal pollution has become a huge environmental and public health issue as their accumulation in the human body may lead to serious health problems. Other metals are essential micronutrients, and they are required for the biological processes of living organisms. As a result, the monitoring of toxic and nutritional elements in consumable products is of great importance.

Therefore, it is desirable—and often necessary—to selectively extract metal ions from aqueous sample matrices such as environmental water, drinking water, beverages, and liquid food matrices. By way of example, beer is a type of alcoholic beverage that is widely consumed all around the world. Although excessive alcohol consumption is associated with a plethora of harmful effects, moderate beer consumption is associated with a wide range of health benefits including decreased cardiovascular risk, decreased risk for diabetes in men, and decreased risk of fracture for elderly people. Natural ingredients used for brewing include water, hops, malted cereals, and yeasts. Typically, the ethanol content of beers varies from 3 to 6%. Beers are relatively rich in some specific nutrients including amino acids, carbohydrates, vitamins, and minerals. The mineral content of beer—including heavy metal content—must be carefully monitored since it can directly affect the quality of the final product.

Different raw materials such as water, malted barley, hops, and yeast are used during beer production, and they might be responsible for metal occurrence in the final product. The content of metals is variable and depends on various factors such as the quality of substrates taken, the type of beer brewed, and the country of origin of the beer. Other sources of metals in beer that originate during their production include the type and the equipment of the brewing process, the storage and the aging of the products, the bottling process, and the adulteration step. For example, traces of lead might occur in beer samples and other alcoholic beverages due to contamination of the raw materials used in beer production and/or due to contamination during their technological processing. Lead poses a significant danger for humans due to its high toxicity, its tendency to accumulate in biological systems, and its long half-life.

Copper is a metal that plays an important technological role in beer. The presence of copper in beer is primarily associated with its presence in raw materials, while it can be also derived from contamination by the containers and brewery equipment. During the production of beer, copper is essential for yeast growth and malt enzymes; its presence at moderate concentration levels is associated with positive effects regarding flavor enhancement and foaming quality. However, elevated concentrations of copper in beer are known to exert a catalytic action causing irreversible haze and gushing. Moreover, high copper concentrations in beer may result in an undesirable metallic taste. In principle, a concentration of copper less than 0.05 mg/L is recommended to ensure beer quality.

Atomic absorption or emission techniques are the most used analytical methodologies for the monitoring of metals in almost any type of matrices. Typical examples of these instrumental techniques used for the elemental assessment of beer samples include electro-thermal atomic absorption spectrometry (ETAAS), flame atomic absorption spectrometry (FAAS), and inductively coupled plasma atomic optical spectrometry (ICP-OES). Among them, FAAS is an attractive option due to its good selectivity and sensitivity in combination with its simplicity, low cost, and ease of operation. Prior to the determination of metals in beer samples by FAAS, the decomposition of the organic matter of beer is required. This can be performed by open-vessel acid digestion. However, due to the simultaneous presence of other potentially interfering species in combination with the low concentration of metals in complex food matrices, a pre-concentration/separation step is typically required after sample decomposition. Thus, automated sample preparation procedures are highly desirable according to the principles of Green Sample Preparation, which results in reduced solvent consumption, reduced waste generation, and minimum operator's exposure to chemicals.

Flow injection (FI) and related techniques have proven to be appropriate for on-line fluidic manipulation and for automated sample processing. On-line automated systems can be highly attractive sample preparation platforms as they can minimize reagent consumption and reduce laboratory time and operation cost involved in the decomposition process, in addition to achieving high extraction efficiency and enhancement factors.

The coupling of FAAS with FI on-line column pre-concentration (FI-FAAS) can serve as an excellent analytical system for metal determination. To date, different sorbent materials have been proposed for on-line metal pre-concentration systems prior to FAAS analysis. Typical examples of such sorbents include hydroxyapatites, metal-organic frameworks, graphene oxide, carbon nanotubes, and silicas. Although a wide variety of on-line systems have been developed and evaluated for their performance with respect to the adsorption of metal ions from environmental and biological samples, the exploration of on-line systems for the determination of toxic and essential elements in beer has been limited.

On the other hand, Alves et al. presented an on-line pre-concentration system for the determination of lead in beer samples using M. oleifera seeds as a bio-sorbent. However, in this approach, no decomposition of the organic matter of the sample was conducted, resulting in questionable accuracy of the method. (Alves et al., Determination of Low Levels of Lead in Beer Using Solid-Phase Extraction and Detection by Flame Atomic Absorption Spectrometry, Journal of Automated Methods and Management in Chemistry, 1-6 (2011)).

All things considered, there is a need to develop on-line column pre-concentration and analysis systems for the assessment of aqueous sample matrices.

Currently, great attention has been paid to the development of novel sorbents using sol-gel technology, due to its ability to provide chemically and thermally stable sorbent phases based on monolithic beds and surface-bonded hybrid organic-inorganic polymer coatings. Moreover, a plethora of sol-gel materials with different surface properties, morphology, and pore structures can be obtained by modifying the synthesis procedure and conditions.

Sol-gel technology has been proven to be a significant tool for the preparation of advanced hybrid inorganic-organic polymer coatings. This technology enables the chemical integration of the sol-gel sorbent to the substrate in a wide variety of forms (e.g., as particles, fiber, fabric etc.). Sol-gel materials can exhibit various advantages, such as tunable porosity, selectivity, as well as good chemical and thermal stability and thus they offer an excellent choice for fabricating automated on-line renewable microcolumn pre-concentration platforms for multi-element analysis. Although sol-gel materials have been proven to be powerful sorbents for the microextraction of organic compounds, the applications of sol-gel materials for the development of analytical techniques for metals have been limited and they have been typically applied as in-tube or capillary surface coatings.

In U.S. Pat. No. 11,506,642, the present inventors have proposed a thiocyanatopropyl functionalized sol-gel silica sorbent for extracting metals from aqueous samples.

However, there is still a need to develop new materials, systems and methods for determining, monitoring and extracting metals including heavy metals in environmental and consumable samples. There is also a need for developing improved sorbent and coating formulation that is efficient and environmentally friendly for selective extraction of metal ions from aqueous sample matrix.

### BRIEF SUMMARY OF THE INVENTION

The present invention provides materials, devices and methods utilizing a novel pyridylethylthiopropyl functionalized sol-gel silica-based sorbent, for detecting, determining, monitoring, extracting and/or pre-concentrating target analytes such as heavy metals (e.g., cadmium, lead, copper, chromium, cobalt, nickel, zinc, manganese, mercury, and vanadium) in fluid samples such as environmental water, drinking water, beverages, and liquid food matrices.

The novel pyridylethylthiopropyl functionalized sol-gel silica-based sorbent according to the present invention has many advantages over classical sorbents used for metal extraction. For example, 1) the pyridylethylthiopropyl functionalized sol-gel silica-based sorbent can be synthesized in situ at ambient conditions; 2) it has high affinity towards a broad range of metals; 3) it has higher selectivity for target metals; 4) it has improved analytical performance characteristics (e.g., limits of detection, pre-concentration time); 5) it can be easily regenerated and used many times; 6) the same formulation can be used to create monolithic bed, particles, as well as surface coating; and 7) because the synthesis of the sorbent particles does not require a substrate as in the case of solid phase extraction sorbents, the sorbent particles serve as the extracting material and offer very high adsorption capacity per unit mass of the sorbent.

In some embodiments, the present invention provides a method for synthesizing the pyridylethylthiopropyl functionalized sol-gel silica-based sorbents. As non-limiting examples, the sorbent is synthesized via a sol-gel reaction by employing a pyridylethylthiopropyl functionalized precursor and a network precursor (such as tetraethyl orthosilicate (TEOS) and/or tetramethyl orthosilicate (TMOS)) in the same or separate solvents, being hydrolyzed in the presence of an acidic catalyst, followed by polycondensation with a basic catalyst.

In some embodiments, the present invention provides a novel separation apparatus and a method that utilizes a pyridylethylthiopropyl functionalized sol-gel silica-based sorbent of the present invention, to extract and/or pre-concentrate one or more metals from a fluid sample.

In some embodiments, the present invention provides a novel on-line sample pre-concentration platform utilizing a separation apparatus according to the present invention comprising a pyridylethylthiopropyl functionalized sol-gel silica-based sorbent of the present invention and coupled with an appropriate detector.

The sorbents according to the present invention are robust and can be used many times that can reduce the overall analysis cost per sample.

### BRIEF DESCRIPTION OF THE DRAWINGS

FIG. 1 shows a proposed mechanism of interactions between metal ions, ammonium pyrrolidine dithiocarbamate (APDC), and pyridylethylthiopropyl functionalized sol-gel silica particles.

FIG. 2A shows a scanning electron microscopy (SEM) image of pyridylethylthiopropyl functionalized silica particles according to the present invention at 5,000× magnifications.

FIG. 2B shows Energy-dispersive X-ray (EDS) spectra of pyridylethylthiopropyl functionalized silica particles according to the present invention.

FIG. 3A shows Fourier transform infrared (FT-IR) spectra of pyridylethylthiopropyl functionalized sol-gel silica particles according to the present invention.

FIG. 3B shows Fourier transform infrared (FT-IR) spectra of 3-(2-pyridylethyl) thiopropyl trimethoxysilane.

FIG. 3C shows Fourier transform infrared (FT-IR) spectra of tetramethyl orthosilicate.

FIG. 4 shows schematic diagrams of the FI-FAAS manifold for Cu(II) and Pb(II) determination.

### DETAILED DESCRIPTION OF THE INVENTION

In one aspect, the present invention provides sorbents to selectively extract and/or pre-concentrate a broad range of metals from a fluid sample. Preferably, the metal extraction sorbents according to the present invention comprise pyridylethylthiopropyl functionalized sol-gel silica-based sorbents.

In further aspects, the present invention provides materials, devices and methods for selectively detecting, determining, monitoring, extracting, and/or pre-concentrating a broad range of metals in a sample.

In particular embodiments, the broad range of metals are one or more metals found in fluid samples including environmental, biological, pharmaceutical, and/or aqueous samples. In some embodiments, the aqueous samples are consumable samples such as potable water or other beverages such as beer.

In some embodiments, the one or more metals are heavy metals. In specific embodiments, the one or more metals are d-block elements in the periodic table. In further embodiments, the one or metals are cadmium, lead, copper, chromium, cobalt, nickel, zinc, manganese, mercury, vanadium, arsenic, silver, or a combination thereof. In some embodiments, these one or more metals are represented as Cd(II), Pb(II), Cu(II), Cr(VI), Cr(III), Co(II), Ni|(II), Zn(II), Mn(II), Hg(II), V(II), As(III), and Ag(I). In some embodiments, these one or more metals exist in fluid samples as cations such as Cd²⁺, Pb²⁺, Cu²⁺, Cr⁶⁺, Cr³⁺, Co²⁺, Ni²⁺, Zn²⁺, Mn²⁺, Hg²⁺, V²⁺, As³⁺, and Ag⁺, respectively. In further embodiments, the one or more metals are at least copper and lead. In some embodiments, the one or more metals are those that are capable of forming complexes with a chelating agent including dithiocarbamates and dithiophosphates, for example, copper and lead.

The extraction and/or pre-concentration of the one or more metals from a sample with a sorbent according to the present invention can be useful in preparing the sample for further analysis, and/or in assessing the presence, bioaccumulation, and fate of the one or more metals in the environment as well as in the body of a subject. In some embodiments, the fluid sample from which one or metals are extracted and/or pre-concentrated with the sorbent is a consumable sample such as potable water or a beverage such as beer. In other embodiments, the sorbent can be used in water filtration units, including household, industrial, and laboratory settings. In further embodiments, the sorbent can also be used for heavy metal mitigation in wastewater treatment plants.

In some embodiments, the present invention provides a pyridylethylthiopropyl functionalized sol-gel silica-based sorbent as part of a sample pre-concentration platform coupled with an appropriate spectroscopic equipment for the analysis of metals contained in the sample. In some embodiments, such platform comprises a column packed with a sorbent according to the present invention for FI on-line column pre-concentration for subsequent analysis, such as by FAAS. By way of example, a sorbent according to the present invention can be loaded to a column to which a fluid sample to be analyzed is introduced, such that one or more metals from the fluid sample are extracted as the sample runs through the column. The extracted metals are desorbed from the sorbent, e.g., by elution with an eluent, and transferred into the nebulizer of a spectroscopic equipment such as FAAS for atomization and quantification of the one or more metals.

In other embodiments, pyridylethylthiopropyl functionalized sol-gel silica-based sorbents of the present invention can be used to prepare samples for other analytical methods such as electro-thermal atomic absorption spectrometry (ETAAS), inductively coupled plasma atomic emission spectroscopy (ICP-AES), inductively coupled plasma mass spectrometry (ICP-MS), and other metal detection and monitoring platform.

According to some embodiments, a fluid sample from which one or more metals are to be extracted by a sorbent of the present invention is exposed to or otherwise mixed with a cheating agent before being introduced to the sorbent. In some embodiments, the chelating agent is ammonium pyrrolidine dithiocarbamate (APDC), sodium diethyldithiocarbamate (DDTC), ammonium diethyl dithiophosphate (DDPA), or a combination thereof. In some embodiments, other dithiocarbamates and/or dithiophosphates may be used to achieve similar results.

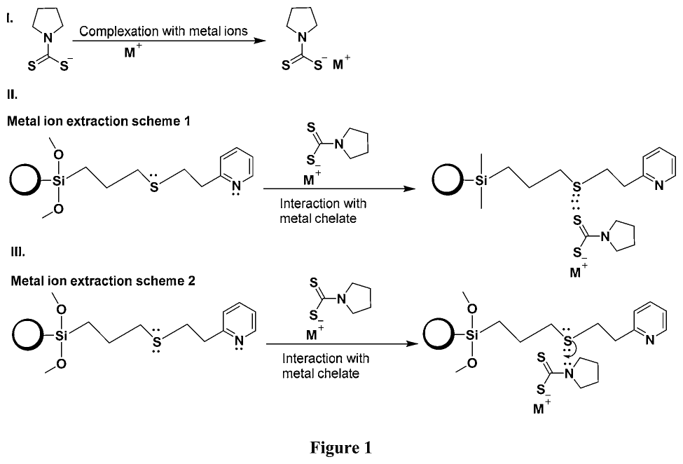

The use of a cheating agent advantageously contributes to the improved selectivity of the pyridylethylthiopropyl functionalized sol-gel silica-based sorbents of the present invention. Therefore, extraction and determination of target metals become more precise when a chelating agent is used. Without this selectivity, more non-target metals could be extracted, resulting in low selectivity, possible interferences, and/or reduction of the active surface of the sorbent. During the development of a method using pyridylethylthiopropyl functionalized sol-gel silica particles as sorbents according to the present invention, it was revealed that the particles did not interact with metal ions in an aqueous sample with high affinity. However, the extraction affinity of the particles was seen to be tremendously improved if a small amount of APDC was added to the aqueous sample matrix. Without being bound by theory, it can be hypothesized that the metal ions present in the aqueous sample matrix first complexes with APDC to form a chelate (FIG. 1). Subsequently, the metal chelates interact with the pyridylethylthiopropyl functionalized sol-gel silica particles via scheme 1 (FIG. 1), scheme 2 (FIG. 1), or both. Thus, in some embodiments, improved selectivity of the pyridylethylthiopropyl functionalized sol-gel silica-based sorbents of the present invention is attributed to the formation of a metal complex with the use of a chelating agent.

Advantageously, the sorbent of the subject invention has the ability to regenerate. Thus, the sorbent can be used in hundreds of operational cycles, thereby substantially reducing treatment costs and the overall analysis cost per sample. In exemplary embodiments, the pyridylethylthiopropyl functionalized sol-gel silica-based sorbents of the present invention exhibit good extraction and pre-concentration performance for metals in a fluid sample and can be used at least, for example, 2, 3, 4, 5, 6, 7, 8, 9, 10, 100, 200, 300, 400, 500, 600, 700, 800, 900, 1,000 times without significantly losing their extraction capacity. In some embodiments, the sorbents are reusable for at least 400 times. In further embodiments, the sorbents are reusable for at least 700 times.

Advantageously, the synthesis and application of pyridylethylthiopropyl functionalized sol-gel silica-based sorbents of the present invention are “green” and inexpensive. The technology has a broad range of applications in household, laboratory and industrial settings, including, but are not limited to, in food and drink safety analysis, water filtration systems, wastewater treatment plants, and environmental laboratories.

### Synthesis of a Sorbent According to the Present Invention

The present invention provides the first successful synthesis of pyridylethylthiopropyl functionalized sol-gel silica-based sorbents that are capable of extracting a broad range of metal species from fluid samples.

In some embodiments, the present invention provides a pyridylethylthiopropyl functionalized sol-gel silica-based sorbent comprising a polymeric network produced from hydrolysis and condensation of precursors, said precursors comprising a pyridylethylthiopropyl functionalized precursor and a network precursor, the pyridylethylthiopropyl functionalized precursor being a sol-gel silica precursor comprising a pyridylethylthiopropyl group. In specific embodiments, the pyridylethylthiopropyl group has the structure of formula (I):

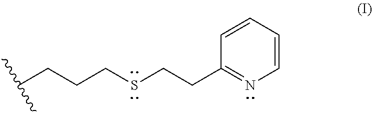 [SMILES: *CCCSCCc1ccccn1]

In some embodiments, the pyridylethylthiopropyl functionalized sol-gel silica-based sorbent according to the present invention can be provided in the form of a monolith, particles, or a surface coating of a substrate. The pyridylethylthiopropyl functionalized sol-gel silica-based sorbent particles can serve as a sorbent material to selectively extract one or more metals from a fluid sample and offer very high adsorption capacity per unit mass of the sorbent.

In further embodiments, a pyridylethylthiopropyl functionalized sol-gel silica-based sorbent according to the present invention is advantageously synthesized in situ at ambient temperature by a sol-gel process. The sol-gel process according to the present invention proceeds by hydrolysis of precursors and condensation of the hydrolyzed precursors. The process forms a colloidal solution (“sol”) of the precursors, which subsequently evolves into a three-dimensional polymeric network (“gel”).

The sol-gel precursors according to the present invention comprise at least a pyridylethylthiopropyl functionalized precursor and a network precursor, the pyridylethylthiopropyl functionalized precursor being a sol-gel silica precursor comprising a pyridylethylthiopropyl group.

In some embodiments, a pyridylethylthiopropyl functionalized precursor and a network precursor can be combined before they are hydrolyzed. Alternatively, hydrolysis or partial hydrolysis can be carried out separately for a pyridylethylthiopropyl functionalized precursor and a network precursor before they are combined for further hydrolysis and/or condensation. In some embodiments where more than one type of pyridylethylthiopropyl functionalized precursor and/or network precursor is used, all or some of such precursors can be combined before they are hydrolyzed, while other precursors are separately hydrolyzed before they are combined with other types of precursors. Alternatively, hydrolysis or partial hydrolysis can be carried out for each pyridylethylthiopropyl functionalized precursor and network precursor before they are combined for further hydrolysis and/or condensation.

In some embodiments, a pyridylethylthiopropyl functionalized precursor according to the present invention is a hydrolysable alkoxysilane sol-gel precursor comprising one or more alkoxyl groups or one or more alkyl groups, at least one of the alkoxyl and/or alkyl groups being substituted by a pyridylethylthiopropyl group. In some embodiments, the alkoxy group can be methoxy, ethoxy, or higher alkoxy groups, such as, but not limited to, n-propoxy, iso-propoxy, n-butoxy, or sec-butoxy groups.

In specific embodiments, the hydrolysable alkoxysilane sol-gel precursor is selected from, for example, tetraalkyl orthosilicates, such as tetramethyl orthosilicate (TMOS), tetraethyl orthosilicate (TEOS) and tetrapropyl orthosilicate (TPOS), alkyl trialkoxysilanes, such as methyltrimethoxysilane (MTMS) and methyltriethoxysilane, and aryl trialkoxysilanes, at least one of the alkoxyl and/or alkyl groups being substituted by a pyridylethylthiopropyl group. In a specific embodiment, the pyridylethylthiopropyl functionalized precursor is 3-(2-pyridylethyl) thiopropyl trimethoxysilane, represented by formula (II).

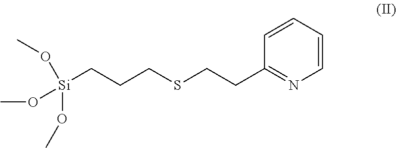 [SMILES: CO[Si](CCCSCCc1ccccn1)(OC)OC]

In some embodiments, a network precursor is selected from tetraalkyl orthosilicates such as tetramethyl orthosilicate (TMOS), tetraethyl orthosilicate (TEOS) and tetrapropyl orthosilicate (TPOS). In further embodiments, a network precursor alternatively or additionally comprises one or more of other types of alkoxysilanes such as alkyltrialkoxysilanes including, but are not limited to, methyltrimethoxysilane (MTMS), methyltriethoxysilane, and ethyltriethoxysilane.

The sol-gel synthesis is typically carried out in a solvent. The solvent can be any solvent that can be removed to a large degree. The solvent can be, but is not limited to, methanol, ethanol, n-propanol, i-propanol, diethyl ether, ethyl acetate, tetrahydrofuran, acetone, methylene chloride, chloroform, acetonitrile, dimethyl sulfoxide, or any compatible mixture thereof. The solvent is preferably one that can be removed by evaporation or washed from the sol-gel material by a volatile solvent. In certain embodiments, the solvent is selected from methanol, ethanol, isopropanol, formic acid, acetonitrile, acetone, and mixtures thereof.

In some embodiments, an acidic catalyst is used to facilitate hydrolysis of the sol-gel precursors according to the present invention. The acidic catalyst according to the present invention includes, but is not limited to, hydrochloric acid (HCl), sulfuric acid (H₂SO₄), nitric acid (HNO₃), trifluoroacetic acid (TFA), hydrogen fluoride (HF), acetic acid, oxalic acid, and a combination thereof. In some embodiments, the acid has a concentration from about 0.01 to about 1M, from about 0.05 to about 1M, from about 0.1M to about 1M, from about 0.1 to about 0.5 M, or from about 0.1 to 0.2M.

In some embodiments, the condensation step resulting in a polymeric network of the sol-gel precursors is base catalyzed. The basic catalyst can be, for example, ammonium hydroxide (NH₄OH) and/or ammonium fluoride (NH₄F).

In some embodiments, the acidic catalyst used is TFA and/or HCl, and the basic catalyst used is NH₄OH.

In some embodiments, the present invention provides a method of synthesizing a pyridylethylthiopropyl functionalized sol-gel silica-based sorbent, the method comprising:
1) mixing a pyridylethylthiopropyl functionalized precursor in the presence of a first solvent to obtain a first “sol” solution;
2) hydrolyzing the pyridylethylthiopropyl functionalized precursor in the solution of step 1) in the presence of a first acidic catalyst;
3) mixing a network precursor in the presence of a second solvent to obtain a second “sol” solution;
4) hydrolyzing the network precursor in the solution of step 3) in the presence of a second acidic catalyst; and
5) combining both hydrolyzed solutions and optionally adding thereto a basic catalyst under constant stirring to facilitate polycondensation to obtain a gel,
said first and second acidic catalysts being same or different, and said first and second solvents being same or different. In specific embodiments, the first and second acidic catalysts as well as the first and second solvents are all the same.

In some embodiments, the method for synthesizing a pyridylethylthiopropyl functionalized sol-gel silica-based sorbent further comprises incubating the mixture of step 5) to form a polymer network and allowing the network to age. The method can also comprise an incubating step between each of the other steps.

As described earlier, in alternative embodiments, a pyridylethylthiopropyl functionalized precursor and a network precursor can be combined before they are hydrolyzed instead of steps 1)-4) above, such that all sol-gel precursors are hydrolyzed in one solution. In some embodiments where more than one type of pyridylethylthiopropyl functionalized precursor and/or network precursor is used, all or some of such precursors can be combined before they are hydrolyzed, while other precursors are separately hydrolyzed before they are combined with other precursors for condensation. Alternatively, hydrolysis or partial hydrolysis can be carried out for each pyridylethylthiopropyl functionalized precursor and network precursor before they are combined for further hydrolysis and/or condensation.

In certain embodiments where sol-gel precursors are being hydrolyzed in separate solutions, the acidic catalysts and solvents being used in each solution may be the same as or different from other solution(s). In specific embodiments, the acidic catalyst and solvent being used in individual solutions are all the same.

In further embodiments, a pyridylethylthiopropyl functionalized precursor and a network precursor in the sol solution have a molar ratio of at least, for example, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10 or any ratio therebetween. A pyridylethylthiopropyl functionalized precursor and a solvent in the sol solution have a molar ratio, for example, from 1:1 to 1:100, from 1:1 to 1:90, from 1:1 to 1:80, from 1:1 to 1:70, from 1:1 to 1:60, from 1:1 to 1:50, from 1:1 to 1:40, from 1:1 to 1:30, from 1:1 to 1:20, from 1:1 to 1:10, from 1:5 to 1:50, from 1:10 to 1:50, from 1:15 to 1:50, from 1:20 to 1:50, or from 1:25 to 1:50.

In some embodiments, the acidic catalyst may be added in the mixture at a molar ratio, between the network precursor and the acidic catalyst, of at least 1:1, 1:2, 1:3, 1:4, 1:5, 1:6, 1:7, 1:8, 1:9, 1:10 or any ratio therebetween. In other embodiments, the basic catalyst may be added in the mixture at a molar ratio, between the network precursor and the basic catalyst, of at least 1:1, 1:2, 1:3, 1:4, 1:5, 1:6, 1:7, 1:8, 1:9, 1:10 or any ratio therebetween.

In one embodiment, the hydrolysis and/or polycondensation steps may be performed at an elevated temperature, for example, ≥40° C., ≥50° C., ≥60° C., ≥70° C. or ≥80° C. In some embodiments, the hydrolysis and/or polycondensation steps are performed at about 50° C. to about 60° C., more preferably at about 60° C.

It is contemplated that a pyridylethylthiopropyl functionalized sol-gel silica-based sorbent of the present invention may be synthesized with auxiliary sol-gel precursors in addition to pyridylethylthiopropyl functionalized precursors and network precursors. Such auxiliary sol-gel precursors may have a functional group, as long as it does not adversely alter the metal-extracting function of the sorbent. In some embodiments, an auxiliary sol-gel precursor according to the present invention contains a phenyl, methacryloxypropyl, and/or aminopropyl functional group. In some embodiments, one or more of the auxiliary sol-gel precursors, when incorporated into a sorbent of the present invention, extend additional intermolecular interactions toward a complex of a metal and a chelating agent.

Advantageously, in embodiments of the present invention, a single formulation of precursors can be used to create a pyridylethylthiopropyl functionalized sol-gel silica-based sorbent material in the form of a monolith, particles, as well as a surface coating on a substrate. These forms may generally be obtained by processes known in the art.

In some embodiments, a sorbent according to the present invention is formed into a sol-gel monolith first and then crushed into particles for easy application. In some embodiments of particle formation, acid-catalyzed hydrolysis and base-catalyzed condensation are used. In other embodiments, only a base catalyst such as ammonium hydroxide is utilized for particle formation, without an independent acid catalyst. In some embodiments where a precursor is basic in nature, it may serve as a basic catalyst and no independent basic catalyst is necessary.

In some embodiments, surface coating of pyridylethylthiopropyl functionalized sol-gel silica-based sorbent is done on various substrates, for example, silica, titania, cellulose, or magnetic particles. Surface coating can be achieved by any process known in the art, such as dip coating, spray coating, or spin coating process. In some embodiments, a substrate for surface coating according to the present invention is any material having a sol-gel active surface containing (or capable of having) free, reactive hydroxyl functional groups, such as glass, fabric, and metal. According to some embodiments, surface coating of a substrate can proceed by sol-gel process, by reacting the surface of a substrate with hydrolyzed precursors comprising a pyridylethylthiopropyl group to form a three-dimensional polymeric network through condensation.

In certain embodiments of the surface coating process, no separate and independent basic catalyst (such as ammonium hydroxide (NH₄OH) solution) is needed whereas a particle-forming process using otherwise the same formulation would. This is because the precursors functionalized with a pyridylethylthiopropyl group (e.g., 3-(2-pyridylethyl) thiopropyl trimethoxysilane) can serve as a basic catalyst in the sol solution. In other embodiments, a small volume of ammonium hydroxide (e.g., 1M) can be added as an independent catalyst to obtain faster gelation and thicker surface coating.

In further embodiments after the completion of gel formation, the gel product undergoes washing and drying processes, and where the sorbent is desired in the form of particles, the gel undergoes a process to reduce it into a desired particle size such as crushing, pulverizing, or grinding. Drying may take place at room temperature, or at a higher temperature so long as the temperature does not disrupt the integrity and/or function of the gel.

In some embodiments, the method of synthesizing a pyridylethylthiopropyl functionalized sol-gel silica-based sorbent further comprises:
drying the synthesized sol-gel sorbent gel;
crushing and/or pulverizing the dried sol-gel sorbent into fine particles;
cleaning the crushed sol-gel sorbent, the cleaning comprising mixing the crushed sorbent with a cleaning solution, and the cleaning solution comprising a mixture of methanol and methylene chloride; and
drying the crushed sol-gel sorbent.

### Extraction, Pre-Concentration, and Analysis of Metals

In some embodiments, the present invention provides a novel separation apparatus (e.g., a column (including a microcolumn), a syringe, a pouch, or a packet, etc.) that utilizes a pyridylethylthiopropyl functionalized sol-gel silica-based sorbent of the present invention, to extract and/or pre-concentrate one or more metals from a fluid sample. In further embodiments, the separation apparatus can be repacked with the same or different pyridylethylthiopropyl functionalized sol-gel silica-based sorbent of the present invention.

The separation apparatus comprising a pyridylethylthiopropyl functionalized sol-gel silica-based sorbent according to the present invention offers a limited flow resistance, excellent packing reproducibility, good pre-concentration efficiency, as well as sensitivity. In some embodiments, this novel separation apparatus is reusable for at least 2, 3, 4, 5, 6, 7, 8, 9, 10, 100, 200, 300, 400, 500, 600, 700, 800, 900, 1,000 loading/elution cycles without significantly sacrificing their performance level. According to some embodiments, the novel separation apparatus is reusable for, for example, at least 400 loading/elution cycles. In further embodiments, the novel separation apparatus is reusable for at least 700 loading/elution cycles.

In some embodiments, the one or more metals are selected from, for example, cadmium, lead, copper, chromium, cobalt, nickel, zinc, manganese, mercury, vanadium, arsenic, silver, and a combination thereof. In further embodiments, the one or more metals are represented as Cd(II), Pb(II), Cu(II), Cr(III), Co(II), Ni|(II), Zn(II), Mn(II), Hg(II), V(II), As(III), and Ag(I). In some embodiments, these one or more metals exist in fluid samples as cations such as Cd²⁺, Pb²⁺, Cu²⁺, Cr⁶⁺, Cr³⁺, Co²⁺, Ni²⁺, Zn²⁺, Mn²⁺, Hg²⁺, V²⁺, As³⁺, and Ag⁺, respectively. In further embodiments, the one or more metals are at least copper and lead. In some embodiments, the one or more metals are those that are capable of forming complexes with a chelating agent including dithiocarbamates and dithiophosphates, for example, copper and lead.

In some embodiments, the present invention provides a method for extracting or pre-concentrating one or more metals from a fluid sample, the method comprising:
1) providing a novel separation apparatus comprising a pyridylethylthiopropyl functionalized sol-gel silica-based sorbent, the apparatus being, for example, a column, a syringe, a pouch, or a packet; and
2) passing the fluid sample through the apparatus, the fluid sample being merged or otherwise mixed with a metal chelating reagent before it is passed through the apparatus, such that the one or more metals are retained in said apparatus.

In some embodiments, the present invention provides a novel on-line sample pre-concentration platform utilizing a separation apparatus according to the present invention (e.g., a microcolumn, a syringe, a pouch, or a packet, etc.) comprising a pyridylethylthiopropyl functionalized sol-gel silica-based sorbent of the present invention. According to some embodiments, this platform is coupled with an appropriate detector (e.g., spectroscopic equipment) for carrying out multi-element (metal) analysis.

In some embodiments, the present invention provides a flow injection (FI) system for on-line extraction and pre-concentration of one or more metals from a sample, comprising a microcolumn comprising a pyridylethylthiopropyl functionalized sol-gel silica-based sorbent, the microcolumn being in fluid communication with an injection valve (e.g., a 5-port 2-position injection valve) and a detector (e.g., a spectroscopic equipment). Preferably, operation of the FI-system is automated such that the extraction and pre-concentration (and optionally detection) of the one or more metals are automatically conducted and controlled by a software. In some embodiments, the detector is FAAS, ETAAS, ICP-AES, ICP-MS, or other metal detection and monitoring platform. In a specific embodiment, the detector is FAAS.

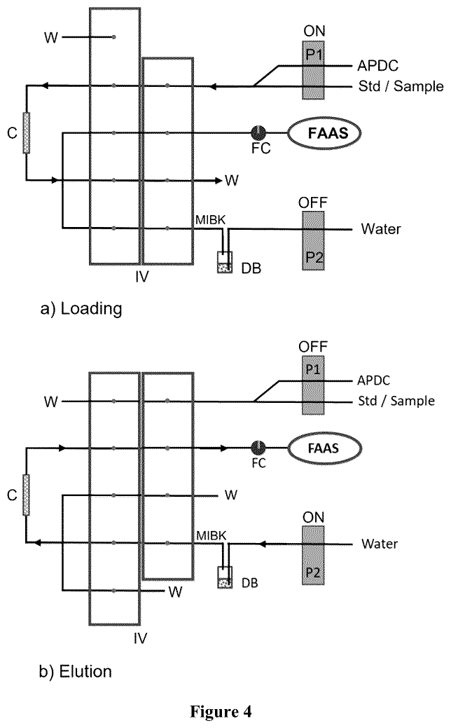

In specific embodiments, the present invention provides a flow injection (FI) system for on-line column extraction and/or pre-concentration of one or more metals coupled with an FAAS (FI-FAAS), represented schematically in FIG. 4. The system comprises two peristatic pumps P1 and P2; P1 for the delivery of a sample solution and a chelating agent simultaneously, and P2 for the propulsion of water into the displacement bottle (DB) resulting in the propulsion of an eluent (e.g., “MIBK”) through the microcolumn (C). The system further comprises a 5-port 2-position injection valve (IV) having two positions: loading (a) and elution (b). The IV integrates the microcolumn (C), which is packed with a pyridylethylthiopropyl functionalized sol-gel silica-based sorbent according to the present invention, at ports 2 and 4, and connecting tube, the tube preferably being made of polytetrafluoroethylene (PTFE) with an internal diameter of about 0.5 mm. Preferably, the connecting tube between the nebulizer of FAAS and the IV is as short as possible to minimize the dispersion of the analyte in the eluent zone. In further embodiments, for flow compensation purposes, a “T” type mixing connector (flow compensation unit “FC”) is adapted between the flow injection system manifold and the FAAS nebulizer.

In some embodiments, the injection valve controls the directions of a sample, eluent, and waste solution (W) flowing through the system.

In some embodiments, a flow injection system for on-line pre-concentration and/or extraction of one or more metals coupled with a detector comprises:
(a) a first peristatic pump for introducing a sample and optionally, a chelating agent;
(b) a second peristatic pump for introducing an eluent;
(c) an injection valve having at least two positions, a first position being for loading the sample to extract the one or more metals and a second position being for eluting the one or more metals;
(d) a separation apparatus such as a microcolumn comprising a pyridylethylthiopropyl functionalized sol-gel silica-based sorbent according to the present invention; and
(e) tubes that connect the injection valve, the first peristatic pump, the second peristatic pump, and the separation apparatus, and the detector (e.g., a nebulizer of the detector) such that the injection valve, the separation apparatus, and the detector are in fluidic communication, and
   when the injection valve is in the loading position, the first peristaltic pump is activated to propel the sample and the chelating agent simultaneously so as to create a mixture, which is forwarded to and retained in the separation apparatus, and
   when the injection valve is in the elution position, the second peristatic pump is activated to propel the eluent through the separation apparatus, and the eluted one or more metals are transferred into the detector for identification and/or quantification.

In some embodiments, the present invention provides a method for detecting, determining, monitoring, extracting and/or pre-concentrating one or more metals from a fluid sample, the method comprising:
1) providing a separation apparatus (e.g., a column, a syringe, a pouch, or a packet) comprising a pyridylethylthiopropyl functionalized sol-gel silica-based sorbent;
2) passing the fluid sample through the separation apparatus;
3) passing an eluent through the separation apparatus to obtain the eluent containing the one or more metals;
4) detecting the one or more metals; and
optionally, quantifying the concentration of the one or more metals, and
optionally, the fluid sample is merged or otherwise mixed with a metal chelating reagent before it is passed through the separation apparatus in step 2).

In some embodiments, the detection and/or quantification can be performed by flame atomic absorption spectrometry (FAAS), electro-thermal atomic absorption spectrometry (ETAAS), inductively coupled plasma atomic emission spectroscopy (ICP-AES), inductively coupled plasma mass spectrometry (ICP-MS), or other metal detection and monitoring platform.

In some embodiments, the one or more metals are cadmium, lead, copper, chromium, cobalt, nickel, zinc, manganese, mercury, vanadium, arsenic, silver, and a combination thereof. In some embodiments, these one or more metals are represented as Cd(II), Pb(II), Cu(II), Cr(VI), Cr(III), Co(II), Ni|(II), Zn(II), Mn(II), Hg(II), V(II), As(III), and Ag(I). In some embodiments, these one or more metals exist in fluid samples as cations such as Cd²⁺, Pb²⁺, Cu²⁺, Cr⁶⁺, Cr³⁺, Co²⁺, Ni²⁺, Zn²⁺, Mn²⁺, Hg²⁺, V²⁺, As³⁺, and Ag⁺, respectively. In further embodiments, the one or more metals are at least copper and lead. In some embodiments, the one or more metals are those that are capable of forming complexes with a chelating agent including dithiocarbamates and dithiophosphates, for example, copper and lead.

In specific embodiments, the fluid sample is selected from, for example, physiological fluids, forensic specimens, environmental pollutants, food samples, beverage samples, pharmaceutical samples, chemical samples, drug residues and metabolites thereof, and poison residues and metabolites thereof. In some embodiments, the fluid sample is beer or potable water.

In some embodiments, the loading time of a fluid sample according to the present invention (a period of time during which the sample (mixed with a chelating agent) is retained within a separation apparatus) is from about 30 seconds to about 360 seconds, from about 30 to about 180 seconds, from about 40 seconds to about 180 seconds, from about 50 seconds to about 180 seconds, or from about 60 seconds to about 180 seconds. In some embodiments, the loading time of a fluid sample according to the present invention is about 30, 40, 50, 60, 70, 80, 90, 100, 110, 120, 130, 140, 150, 160, 170, or 180 seconds. In some embodiments, the loading time is about 60 seconds, 120 seconds, or 180 seconds.

In some embodiments, the fluid sample has a pH value in the range, for example, from about 1.0 to about 3.0, from about 2.0 to about 3.0, from about 2.0 to about 8.0, from about 2.0 to about 7.5, from about 2.0 to about 7.0, from about 2.5 to about 7.0, from about 2.5 to about 6.5, from about 3.0 to about 6.5, from about 3.5 to about 6.5, from about 4.0 to about 7.0, from about 4.0 to about 6.5, from about 4.0 to about 6.0, from about 4.5 to about 6.0, from about 4.0 to about 5.5, from about 4.5 to about 5.5, from about 4.0 to about 5.0, or from about 4.5 to about 5.0. Preferably, the fluid sample has a pH value of from about 2.0 to about 3.0.

A chelating agent according to the present invention can be any chemical compounds that react with metal ions to form a stable, hydrophobic complex. Non-limiting examples of chelating agents that can be used in the present invention include ammonium pyrrolidine dithiocarbamate (APDC), sodium diethyldithiocarbamate (DDTC), ammonium diethyl dithiophosphate (DDPA), or a combination thereof. In some embodiments, other dithiocarbamates and/or dithiophosphates may be used to achieve similar results.

Since it has been hypothesized that a metal-chelator complex formation precedes the extraction process by the sorbent of the present invention, it would be understood by those skilled in the art that “metals” being referred to in connection with extraction, pre-concentration, and/or analysis herein may be in the form of a complex.

The eluent can be any eluent that can elute the one or more metals and does not materially interfere with the subsequent analysis thereof. In some embodiments, the eluent is an organic solvent such as methyl isobutyl ketone (MIBK), diisobutyl keton (DIBK), methanol, or a combination thereof in a solution. In some embodiments, the eluent is an inorganic solvent such as a nitric acid solution having a concentration from about 0.01 mol/L to about 2.5 mol/L, from about 0.05 mol/L to about 2.5 mol/L, from about 0.1 mol/L to about 2 mol/L, from about 0.1 mol/L to about 1.5 mol/L, from about 0.2 mol/L to about 1.5 mol/L, from about 0.5 mol/L to about 1.5 mol/L, from about 1 mol/L to about 2 mol/L, or from about 1 mol/L to about 1.5 mol/L, or more preferably 1 mol/L.

In some embodiments, the sample and/or the eluent passing through the flow injection system of the present invention or otherwise a pyridylethylthiopropyl functionalized sol-gel silica-based sorbent according to the present invention has a loading flow rate (LFR), for example, from about 1 to about 50 mL/min, from about 1 to about 40 mL/min, from about 1 to about 30 mL/min, from about 2 to about 30 mL/min, from about 5 to about 25 mL/min, from about 5 to about 20 mL/min, from about 5 to about 15 mL/min, from about 5 to about 10 mL/min, from about 10 to about 40 mL/min, from about 10 to about 30 mL/min, from about 10 to about 20 mL/min, from about 1 to about 10 mL/min, or from about 1 to about 5 mL/min. In some embodiments, the sample flow rate is preferably from about 9 to about 10 mL/min. In some embodiments, the elution flow rate is preferably from about 3 to about 5 mL/min.

In some embodiments, in the context of a flow injection system according to the present invention, the ratio of the flow rates of a sample to be analyzed and a chelating agent is from about 1.0 to 10.0, from about 2.0 to about 9.0, from about 3.0 to about 7.0, from about 4.0 to about 6.0. In some embodiments, the ratio is from about 3.0 to about 9.0, from about 4.0 to about 8.0, from about 5.0 to about 8.0, from about 6.0 to about 8.0, from about 7.0 to about 8.0. In some embodiments, the ratio is about 8.0.

In some embodiments, the determination of the concentration of one or more metals, e.g., trace metals, comprises comparing the detected result to a standard curve obtained by flowing standard solutions containing each target metal or all target metals at different concentrations through the flow injection system of the present invention or otherwise a pyridylethylthiopropyl functionalized sol-gel silica-based sorbent according to the present invention.

As used herein, the singular forms “a,” “an,” and “the” are intended to include the plural forms as well, unless the context clearly indicates otherwise. Further, to the extent that the terms “including,” “includes,” “having,” “has,” “with,” or variants thereof are used in either the detailed description and/or the claims, such terms are intended to be inclusive in a manner similar to the term “comprising.” The transitional terms/phrases (and any grammatical variations thereof), such as “comprising,” “comprises,” and “comprise,” can be used interchangeably.

The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

Unless specifically stated or obvious from context, as used herein, the term “or” is understood to be inclusive. Unless specifically stated or obvious from context, as used herein, the terms “a,” “an” and “the” are understood to be singular or plural.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 0-20%, 0 to 10%, 0 to 5%, or up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed. In the context of compositions containing amounts of concentrations of ingredients where the term “about” is used, these values include a variation (error range) of 0-10% around the value (X±10%).

### EXAMPLES

Following are Examples which are offered by way of illustration and are not intended to limit the invention. Unless otherwise stated, these Examples utilized the methods, techniques, and materials known in the art. Various modifications or changes in light thereof will be suggested to persons skilled in the art and are to be included within the spirit and purview of this application.

### Reagents, Materials, Samples

Milli-Q water prepared by a Milli-Q (Millipore, Bedford, TX, USA) system was employed throughout the study. Concentrated HNO₃ 65%, NH₄OH 25%, and H₂O₂ 35% purchased by Merck (Darmstadt, Germany) were used for sample digestion and pH adjusting. Stock standard (Titrisol) solutions of lead and copper at a concentration of 1000 mg L⁻¹ in 0.5 mol L⁻¹ HNO₃ were supplied by Merck (Darmstadt, Germany) and they were used to prepare working standard solutions through appropriate serial dilution. All storage bottles and glassware were overnight soaked in diluted HNO₃ to avoid contamination, and they were extensively rinsed with Milli-Q water prior to their use.

The chelating agents, ammonium pyrrolidine dithiocarbamate (APDC) were purchased by Sigma Aldrich (St. Louis, MO, USA) and aqueous solutions of them at the appropriate concentrations were prepared daily.

Methyl isobutyl ketone (MIBK) was obtained by Merck (Darmstadt, Germany) and was used as eluent.

3-(2-pyridylethyl) thiopropyl trimethoxysilane was purchased from Gelest Inc. (Morrisville, PA, USA). Isopropanol, HCl, NH₄OH, and methylene chloride were purchased from Fisher Scientific (Milwaukie, WI, USA). Tetramethyl orthosilicate (TMOS) was purchased from Sigma-Aldrich (St. Louis, MO, USA).

In the analysis of beer samples (Example 3), six brands of different types of Greek beers in cans (BSC 3-6) or glass bottles (BSB 1-2) were purchased during October 2021 from a local market in Thessaloniki, Greece and evaluated for copper and lead. The samples were produced in different regions of Greece and their types and ethanol contents (% v/v) were as follows: BSB-1 Lager 5%; BSB-2 Weiss 5.5%; BSC-3 Lager 4.1%; BSC-4 Bock 6%; BSC-5 Lager 5% BSC-6 Pils 0.0%. For all samples, five replicate measurements were performed.

### Instrumentation

### FAAS

A 5100 PC Perkin-Elmer flame atomic absorption spectrometer (FAAS) (Norwalk, CT, USA, las.perkinelmer.com) was used for the quantification of Pb(II) and Cu(II). An electrodeless discharge lamp operated at 10 W for lead and a hollow cathode lamp operated at 30 mA for copper, were used as light sources. The resonance lines were fixed at 283.3 nm for lead and 324.7 nm for copper. The monochromator spectral bandpass (slit) was set at 0.7 nm for both elements.

During the elution step (Example 3), oxidizing flame was obtained using acetylene and air at flow rates 0.5 L min⁻¹ and 10.0 L min⁻¹ respectively, for both metals. An internal PTFE flow spoiler into the spray chamber was employed to ensure good nebulization conditions, based on the recommendations of the instrument's manufacturer.

### Flow Injection System

A flow injection (FI) system model FIAS-400 Perkin-Elmer (Norwalk, CT, USA) in conjunction with the 5100 PC FAAS was utilized for the automatic on-line microcolumn pre-concentration procedure. This FI manifold was equipped with two individually peristaltic pumps (P1 and P2) with tygon tubing.

### Data Curation and Processing

Data curation and processing were conducted using AA Lab Benchtop version 7.2 software.

### pH Adjustment

A METROHM 654 pH-meter (Metrohm AG, Herisau, Switzerland) was employed for the pH adjusting of sample solutions.

### Example 1—Synthesis of Pyridylethylthiopropyl Functionalized Sol-Gel Silica-Based Sorbent Material

Pyridylethylthiopropyl functionalized sol-gel silica based sorbents of the present invention were prepared according to the methods described below, in the form of particles (a) and surface coating (b). An exemplary formulation of the sorbents according to the present invention is as shown in Table 1:

TABLE 1
A formulation example

| | |
|---|---|
| Solution A | Solution B |

| | | | | | |
|---|---|---|---|---|---|
| Tetramethyl | 4 | mL | 3-(2-pyridylethyl) | 2 | mL |
| Orthosilicate | | | thiopropyl | | |
| | | | trimethoxysilane | | |
| Isopropanol | 20 | mL | Isopropanol | 10 | mL |
| HCl (0.1M) | 1920 | μL | HCl (0.1M) | 500 | μL |

| | |
|---|---|
| The mixture was kept at | The mixture was kept at |
| 50° C. for 12 h to expedite | 50° C. for 12 h to expedite |
| the hydrolysis process | the hydrolysis process |

Solution A and Solution B were mixed together and vortexed for 5 min. Subsequently, 2000 μL of Ammonium Hydroxide solution (1M) was added dropwise to the mixture with constant stirring on a magnetic stirrer. The gel formed in less than an hour.

### (a) Preparation of Pyridylethylthiopropyl Functionalized Sol-Gel Silica Based Sorbent Particles

Two sol solutions were prepared independently in two reaction vessels. The first sol solution was prepared by sequentially adding the sol solution ingredients 3-(2-pyridylethyl) thiopropyl trimethoxysilane, isopropanol, and 0.1 M HCl solution at a molar ratio of 1:18:4, respectively. The reaction mixture was vortexed for 5 min. The sol solution was allowed to undergo hydrolysis at room temperature for 8 h.

The second sol solution was prepared by sequentially adding sol solution ingredients tetramethyl orthosilicate (TMOS), isopropanol, and 0.1M HCl at a molar ratio of 1:10:4, respectively. The sol solution was vortexed for 5 min and the solution was allowed to undergo hydrolysis for 8 h. At the end of the predetermined hydrolysis period, both solutions were mixed together gently with constant stirring on a magnetic stirrer. Subsequently, ammonium hydroxide solution (1.0M) was added dropwise to the solution under constant stirring at a molar ratio of TMOS:ammonium hydroxide (1.0 M) as 1:4. The sol solution was converted into gel in less than 1 h to obtain a sol-gel mass.

This solid sol-gel mass was then thermally aged and conditioned in an oven for 24 h. The sol-gel mass was then crushed and dried in an oven at 100° C. for 24 h. The dried particles were then crushed and ground in a mortar to obtain fine particles of a desired size. The particles were then loaded in a fiberglass thimble to clean from unreacted reagents and reaction byproducts in a Soxhlet extraction unit using methylene chloride as the washing solvent. The pyridylethylthiopropyl functionalized sol-gel silica particles were then dried at 100° C. for 12 h.

### (b) Preparation of Surface Coating

Advantageously, in embodiments of the present invention, the same formulation of a pyridylethylthiopropyl functionalized sol-gel silica-based sorbent can be used to create particles as well as a surface coating of a substrate. The formulation of Table 1 is also used as a surface coating to create microextraction devices by a dip coating, spray coating, or spin coating process.

### Example 2—Characterization of a Pyridylethylthiopropyl Functionalized Sol-Gel Silica-Based Sorbent

The pyridylethylthiopropyl functionalized sol-gel silica-based sorbent particles of Example 1 were characterized using Scanning Electron Microscope (SEM) and Fourier-Transform Infrared Spectroscopy (FT-IR).

a) Scanning Electron Microscopy Equipped with Energy Dispersive Spectrometry (SEM-EDS)

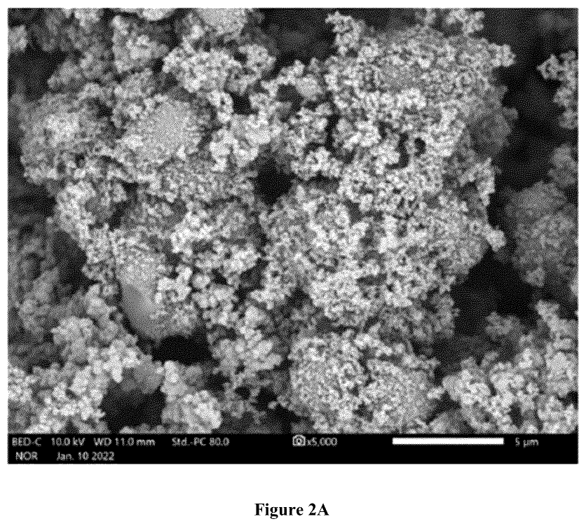

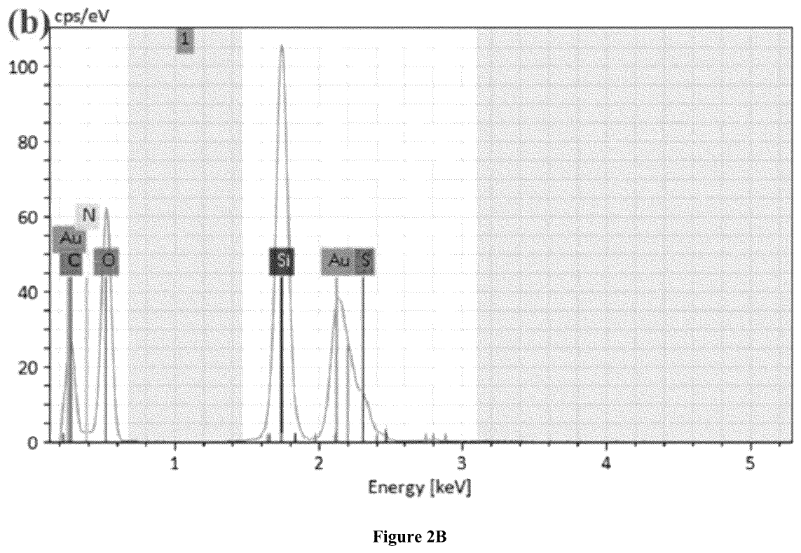

The surface morphology and the elemental composition of pyridylethylthiopropyl functionalized silica particles were studied using a JEOL JSM 5900LV scanning electron microscopy equipped with energy dispersive spectrometry (SEM-EDS). The surface morphology presented in FIG. 2A revealed the incremental growth of the spherical particles around a small particle to form an agglomerated lump of fine particles. The elemental composition was calculated as C, 24.54%, O, 38.62%, Si, 28.38%, S 4.20% and N, 4.25% which fairly corroborate with the sol solution formulation. The EDS spectra is presented in FIG. 2B.

### b) Fourier Transform-Infrared Spectroscopy

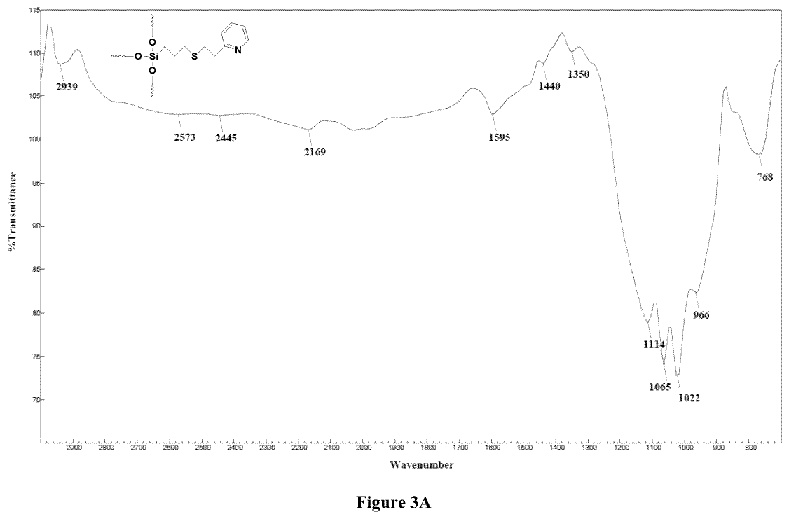

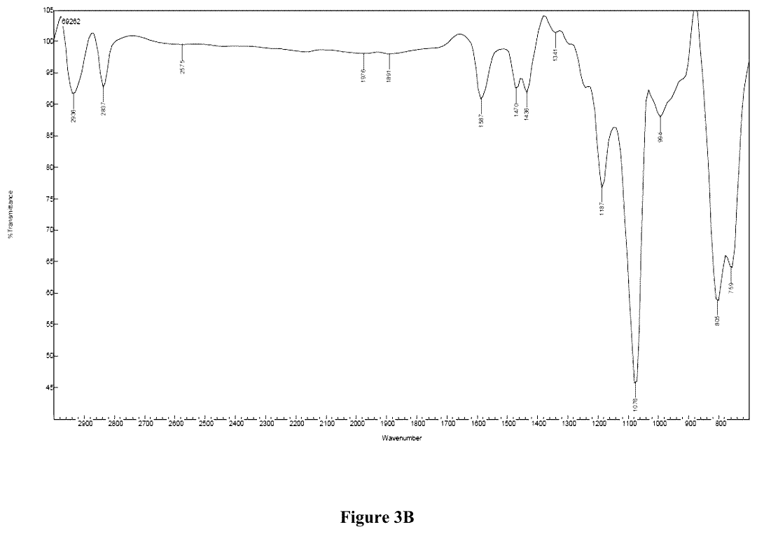

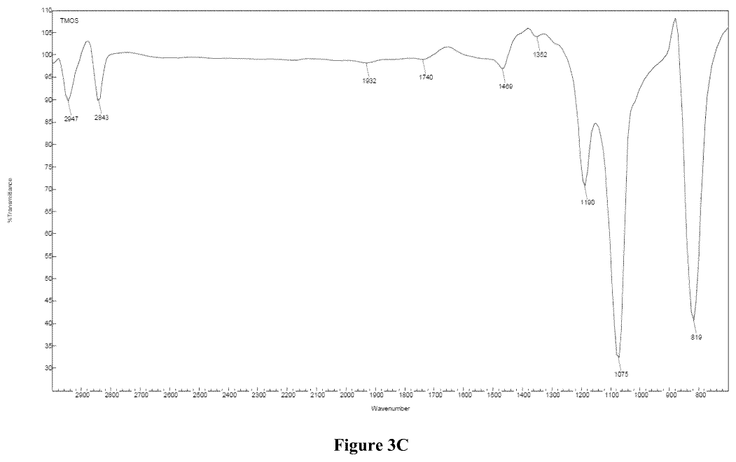

The functional composition of the pyridylethylthiopropyl functionalized sol-gel silica particles were evaluated using a Cary 670 FTIR Spectrometer. The FT-IR spectra of 3-(2-pyridylethyl) thiopropyl trimethoxysilane, tetramethyl orthosilicate (TMOS), and pyridylethylthiopropyl functionalized sol-gel silica particles are presented in FIGS. 3B, 3C, and 3A, respectively. The major bands in the 3-(2-pyridylethyl) thiopropyl trimethoxy silane FT-IR spectra (FIG. 3B) include 2934 cm⁻¹ and 2838 cm⁻¹ representing the presence of C—H stretching vibration. The weak band at 2575 cm⁻¹ represents the —SH bond. The bands at 1587 cm⁻¹ and 1187 cm⁻¹ represent C═N stretching and C—N stretching, respectively. The band at 759 cm⁻¹ corresponds to C—H bond. The band at 1077 cm⁻¹ can be assigned to Si—O—C bond. The characteristics bands in the TMOS FT-IR spectra (FIG. 3C) include bonds at 2948 cm⁻¹ and 2844 cm⁻¹ that represent C—H stretching. The band at 1190 cm⁻¹ represents the asymmetric bending of C—H bonds. The band at 1076 cm⁻¹ can be attributed to Si—O—C bonds.

The FT-IR spectra presented in FIG. 3A represents pyridylethylthiopropyl functionalized sol-gel silica particles. As can be seen, many bands that belong to 3-(2-pyridylethyl) thiopropyl trimethoxysilane and TMOS spectra simultaneously appeared in FT-IR spectra of pyridylethylthiopropyl functionalized sol-gel silica particles. For example, the bands at 2939 cm⁻¹, 2573 cm⁻¹, 1595 cm⁻¹, 1065 cm⁻¹, 786 cm⁻¹ can also be seen either in 3-(2-pyridylethyl) thiopropyl trimethoxysilane FT-IR spectra or in TMOS FT-IR spectra which strongly suggest the successful integration of the sol-gel functional precursor 3-(2-pyridylethyl) thiopropyl trimethoxysilane and the networking precursor TMOS into the final polymeric sorbent pyridylethylthiopropyl functionalized sol-gel silica particles.

### Example 3—Analysis of Beer Samples with FI-FAAS

A FI-FAAS system according to the present invention was employed for the determination of Cu(II) and Pb(II) content in different beer samples. Each sample was analyzed in triplicate.

### a) Assembly of the Microcolumn

A 1000 μL disposable polypropylene syringe (10.0 cm length; 5.0 mm i.d.) was used for the fabrication of the on-line sorbent extraction microcolumn. For this purpose, the syringe barrel was cut to obtain a tube with a length of 25 mm. A quantity of 95 mg (granular between 0.150 and 0.200 μm) of the developed pyridylethylthiopropyl functionalized sol-gel silica-based sorbent particles according to Example 1 were firmly packed within the column tube between two commercial frits to ensure well packing and to avoid any loss of sorbent. The newly prepared microcolumn was flashed initially with dilute 1.0 mol L⁻¹ HNO₃ solution and then with water to remove potential impurities from the sorbent's surface. As such, both the column fabrication and the handling procedure are characterized by simplicity. The proposed sol-gel pyridylethylthiopropyl functionalized silica based packed microcolumn was easy to repack, when necessary, while it was found to be reusable for at least 400 separation/pre-concentration cycles.

### b) Beer Sample Pretreatment

To ensure the complete decomposition of the organic matter in the beer samples, open-vessel wet-acid digestion was conducted. Beer samples were initially degassed using an ultrasonic bath for 30 min at full power and subsequently, the decomposition procedure proposed by Oliveira et al. (1993) was followed after slight modification. Oliveira, E. D. et al., Determination of Trace Elements in Brazilian Beers by ICP-AES, Food Chemistry, 47, 205-207 (1993). In brief, an aliquot of 100 mL of beer samples was placed in a 250 mL Erlenmeyer flask, followed by the addition of 20 mL of concentrated HNO₃. The obtained mixture was heated at 80-90° C., while concentrated H₂O₂ was added dropwise until the solution was clear. After that, the heating was continued until the sample volume was reduced to ca. 40 mL. The obtained solution was transferred to a 50 mL volumetric flask, neutralized with concentrated NH₄OH, the pH value was adjusted to pH=2.0 with dilute HNO₃. The sample volume was made up to the mark with water. Blank solutions were prepared using the same experimental wet digestion procedure.

### c) On-Line Extraction/Column Pre-Concentration Procedure

The automatic on-line solid phase extraction (SPE) column pre-concentration procedure was composed of two main steps, namely sample loading and elution. FIG. 4 demonstrates schematically the on-line manifold in the two steps, utilizing the pyridylethylthiopropyl functionalized sol-gel silica-based sorbent according to the present invention packed into the microcolumn C. Operation of the FI-FAAS system was conducted under time-based mode through the PC software, while the sequences are presented in detailed in Table 2 below.

TABLE 2
Operational steps of the on-line extraction/column preconcentration method

| Operational | IV | Pump | | Dispensed | Flow rate | Time | |
|---|---|---|---|---|---|---|---|
| step | position | P1 | P2 | solution | (mL min⁻¹) | (s) | Operation |
| 1 | Loading | ON | OFF | Std/ | 8.0 | 60 | Preconcentration |
| | | | | sample | | | |
| | | | | APDC | 0.9 | | |
| 2 | Elution | OFF | ON | MIBK | 3.8 | 20 | Elution/ |
| | | | | | | | Measurement |

During the first step of the analytical procedure, the peristaltic pump rate of 0.9 mL min⁻¹ simultaneous with the propulsion of standard or beer sample (blank or spiked) at a flow rate of 8.0 mL min⁻¹. The stream of the chelating reagent (APDC) was merged with the stream of the sample solution, resulting in the on-line quick formation of the metal-APDC complex. The mixture of the two streams, APDC plus sample was forwarded through the microcolumn for a period of 60 s (defined as pre-concentration time). During this step, the injection valve IV was in “loading position,” the metal-APDC complex was retained within the microcolumn, while air is aspirated in the nebulizer of the FAAS using a perpendicular inlet of the flow compensation (FC) adapter. For the elution of the retained complex (step 2), MIBK was propelled through the pyridylethylthiopropyl functionalized sol-gel silica microcolumn at a flow rate of 3.8 mL min⁻¹ utilizing a displacement bottle (DB), to avoid the breakdown of the tygon peristaltic tubes from the organic solvent MIBK. The desorbed complex was directly transferred into the nebulizer of the FAAS for atomization and quantification of metal. During this step, the IV was switched from the “loading position” to the “elution position.” Aiming to minimize the analytes' dispersion into the eluent segment, the flow of the streams during the elution step was in reverse direction compared to the loading step. Under these conditions, stable baseline and sharp recorded peaks were obtained.

### d) Results

The concentration of Cu(II) in the examined samples ranged between 1.6 and 21.8 μg L⁻¹, while the concentration of Pb(II) ranged between 6.9 and 17.6 μg L⁻¹ (see Table 3). These findings are in accordance with the other studies regarding the concentration ranges for the target analytes. (E.g., Cheng, J. et al., Silica Gel Chemically Modified with Ionic Liquid as Novel Sorbent for Solid-phase Extraction and Preconcentration of Lead from Beer and Tea Drink Samples Followed by Flame Atomic Absorption Spectrometric Determination, Food Analytical Methods, 7(5), 1083-1089 (2014); Oliveira, E. D. et al., Determination of Trace Elements in Brazilian Beers by ICP-AES, Food Chemistry, 47, 205-207 (1993)).

In order to assess the accuracy of the proposed method, each sample was directly analyzed by electrothermal atomic absorption spectrometry (ETAAS) without the on-line pre-concentration step. Students t-test was employed to identify the presence of significant differences between the two methods. As it can be observed in Table 3, the tₑₓₚ value was lower than t_{crit}=4.303, which corresponds to a probability level of 95.0%, indicating that the difference between the present method and ETAAS did not differ statistically. Thus, the proposed method can be efficiently employed for the determination of Cu(II) and Pb(II) in different beer samples.

TABLE 3
Determination of Cu(II) and Pb(II) in beer samples

| | Beer | Found | | | Recovery |
|---|---|---|---|---|---|
| | sample | (μg L⁻¹) | ETAAS | tₑₓₚ | (%) |
| Cu(II) | BSB-1 | 3.7 ± 0.10 | 3.5 ± 0.20 | 3.464 | 105.7 |
| | BSB-2 | 12.7 ± 0.40 | 13.2 ± 0.60 | 2.165 | 96.2 |
| | BSB-3 | 2.7 ± 0.10 | 2.9 ± 0.15 | 3.464 | 93.1 |
| | BSB-4 | 1.6 ± 0.06 | 1.7 ± 0.07 | 2.887 | 94.1 |
| | BSB-5 | 21.8 ± 0.06 | 22.5 ± 0.60 | 2.021 | 96.9 |
| | BSB-6 | 20.0 ± 0.50 | 21.1 ± 0.80 | 3.811 | 94.8 |
| Pb(II) | BSB-1 | 17.6 ± 0.50 | 18.3 ± 0.70 | 2.425 | 96.2 |
| | BSB-2 | 13.2 ± 0.40 | 12.5 ± 0.60 | 3.031 | 105.6 |
| | BSB-3 | 7.3 ± 0.30 | 7.9 ± 0.40 | 3.464 | 104.0 |
| | BSB-4 | 7.8 ± 0.18 | 8.1 ± 0.50 | 2.887 | 96.3 |
| | BSB-5 | 6.9 ± 0.25 | 6.5 ± 0.30 | 2.771 | 93.3 |
| | BSB-6 | 7.3 ± 0.20 | 7.5 ± 0.30 | 1.732 | 97.3 |

Furthermore, the analytical performance characteristics (e.g., limits of detection, pre-concentration time) of the pyridylethylthiopropyl functionalized sol-gel silica-based sorbent according to the present invention were better than the results obtained using a microcolumn comprising thiocyanatopropyl functionalized sol-gel silica sorbent as a front-end to the same detection technique (FAAS). See Manousi et al., Automated Solid Phase Extraction of Cd(II), Co(II), Cu(II) and Pb(II) Coupled with Flame Atomic Absorption Spectrometry Utilizing a New Sol-Gel Functionalized Silica Sorbent, Separations, (8) 100 (2021).

All patents, patent applications, provisional applications, and publications referred to or cited herein are incorporated by reference in their entirety, including all figures and tables, to the extent they are not inconsistent with the explicit teachings of this specification.

We claim:

1. A pyridylethylthiopropyl functionalized sol-gel silica-based sorbent comprising a polymeric network produced from hydrolysis and condensation of precursors, said precursors comprising pyridylethylthiopropyl functionalized precursor and a network precursor, the pyridylethylthiopropyl functionalized precursor being a sol-gel silica precursor comprising a pyridylethylthiopropyl group.

2. The sorbent of claim 1, the pyridylethylthiopropyl functionalized precursor being a hydrolysable alkoxysilane sol-gel precursor comprising one or more alkoxyl groups or one or more alkyl groups, at least one of the alkoxyl and/or alkyl groups being substituted by a pyridylethylthiopropyl group.

3. The sorbent of claim 1, the pyridylethylthiopropyl functionalized precursor being 3-(2-pyridylethyl) thiopropyl trimethoxysilane, represented by formula (II):

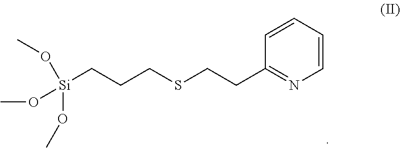 [SMILES: CO[Si](CCCSCCc1ccccn1)(OC)OC]

4. The sorbent of claim 1, the network precursor being a tetraalkyl orthosilicate, a alkyltrialkoxysilanes, or a combination thereof.

5. The sorbent of claim 1, the network precursor being tetramethyl orthosilicate (TMOS), tetraethyl orthosilicate (TEOS), tetrapropyl orthosilicate (TPOS), methyltrimethoxysilane (MTMS), methyltriethoxysilane, ethyltriethoxysilane, or a combination thereof.

6. The sorbent of claim 1, said hydrolysis being catalyzed by hydrochloric acid (HCl), sulfuric acid (H₂SO₄), nitric acid (HNO₃), trifluoroacetic acid (TFA), hydrogen fluoride (HF), acetic acid, oxalic acid, or a combination thereof.

7. The sorbent of claim 1, said condensation being catalyzed by NH₄OH, NH₄F, or a combination thereof.

8. The sorbent of claim 1 being suitable to be produced as particles and a surface coating of a substrate.

9. The sorbent of claim 1, said pyridylethylthiopropyl group having the structure (I):

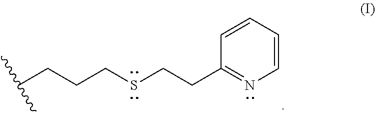 [SMILES: *CCCSCCc1ccccn1]

10. A method for synthesizing the pyridylethylthiopropyl functionalized sol-gel silica-based sorbent of claim 1, the method comprising:
mixing a pyridylethylthiopropyl functionalized precursor with a first solvent and a first acidic catalyst to form a first solution;
mixing a network precursor with a second solvent and a second acidic catalyst to form a second solution;
combining the first and second solutions to form a mixture; and
allowing the mixture to form a gel.

11. The method of claim 10, the pyridylethylthiopropyl functionalized precursor being 3-(2-pyridylethyl) thiopropyl trimethoxysilane, represented by formula (II):

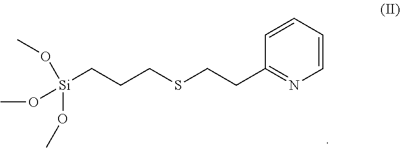 [SMILES: CO[Si](CCCSCCc1ccccn1)(OC)OC]

12. The method of claim 10, the network precursor being a tetraalkyl orthosilicate, a alkyltrialkoxysilanes, or a combination thereof.

13. The method of claim 10, the network precursor being tetramethyl orthosilicate (TMOS), tetraethyl orthosilicate (TEOS), tetrapropyl orthosilicate (TPOS), methyltrimethoxysilane (MTMS), methyltriethoxysilane, ethyltriethoxysilane, or a combination thereof.

14. The method of claim 10, said first and second acidic catalysts each independently being hydrochloric acid (HCl), sulfuric acid (H₂SO₄), nitric acid (HNO₃), trifluoroacetic acid (TFA), hydrogen fluoride (HF), acetic acid, oxalic acid, or a combination thereof.

15. The method of claim 10, a basic catalyst being added to the mixture to facilitate said gel formation.

16. The method of claim 10, said sorbent being suitable to be produced as particles or a surface coating of a substrate.

17. A flow injection system for extraction and/or pre-concentration of one or more metals from a fluid sample, comprising a separation apparatus comprising the pyridylethylthiopropyl functionalized sol-gel silica-based sorbent of claim 1 in fluid communication with an injection valve and a detector.

18. The flow injection system of claim 17, the one or more metals being selected from cadmium, lead, copper, chromium, cobalt, nickel, zinc, manganese, mercury, vanadium, arsenic, silver, and a combination thereof.

19. The flow injection system of claim 17, the detector being FAAS, ETAAS, ICP-AES, ICP-MS, or other metal detection and monitoring platform.

20. A method for detecting and/or quantifying one or more metals in a fluid sample, the method comprising:
combining the fluid sample with a chelating agent;
passing the combined fluid sample and chelating agent through the flow injection system of claim 17;
passing an eluent through the flow injection system to obtain the eluent with the one or more metals; and
detecting the one or more metals.
